(19) United States
(12) Patent Application Publication
(10) Pub. No.: US 2021/0327052 A1
(43) Pub. Date: Oct. 21, 2021

(54) DETECTION OF NERVES IN A SERIES OF ECHOGRAPHIC IMAGES

(71) Applicant: Adel HAFIANE, (US)

(72) Inventor: Adel HAFIANE, (US)

(21) Appl. No.: 16/467,807

(22) PCT Filed: Dec. 8, 2017
(86) PCT No.: PCT/FR17/53457

§ 371 Date: Jun. 7, 2019

(30) Foreign Application Priority Data
Dec. 9, 2016 (FR) 1662238

(51) Int. Cl. G06T 7/00; G06T 7/73; G06T 7/77

(52) U.S. Cl. CPC G06T 7/0012; G06T 7/75; G06T 7/77; G06T 2207/30024; G06T 2207/20064; G06T 2207/20081; G06T 2207/20084; G06T 2207/10016

(57) ABSTRACT

A method for detecting a nerve in a series of echographic images comprising, for each image of the series:
a step (E2) of generating a map of probabilities over regions of the image, involving applying a plurality of pattern descriptors in order to generate, for each pixel, a vector determining the response of the pixel for each of the descriptors, then deducing a probability for each pixel of belonging to a nerve as a function of a probabilistic model;
a classification step (E3) applied on zones determined by this probability map, involving searching models corresponding to a nerve type, in a sliding window over these zones, assigning a degree of confidence to each position of the window and retaining an optimum position for each model, then analyzing the consistency of these optimum positions by measuring their stability over a set of images of the series in order to select the window exhibiting the maximum consistency, which window corresponds to a detected nerve.

### RELATED APPLICATIONS

This present application is a National Phase entry of PCT Application No. PCT/FR2017/053457 filed Dec. 8, 2017, which claims priority to French Application No. 1662238 filed Dec. 9, 2016, the contents of each being incorporated herein by reference in their entireties.

### TECHNICAL FIELD

The invention relates to the field of analyzing digital images originating from ultrasound scans. More specifically, embodiments to the automatic detection of a nerve in a series of images in order to assist the work of an anesthetist.

### BACKGROUND ART

Locoregional anesthesia involves injecting the anesthetic product in the vicinity of a nerve of the patient. Therefore, it is important that the anesthetist has a tool that facilitates their work by allowing them to precisely locate the nerves. To this end, they have equipment that allows them to have a real-time view of an echographic image of the studied zone of the anatomy of the patient. The anesthetist can scan the zone in order to find the nerves and determine the suitable location for inserting the anesthetic product.

However, detecting nerves in an echographic image is a difficult task, even for an experienced anesthetist.

Therefore, allowing the anesthetist to have automatic tools assisting them in their task is of interest. Embodiments of the invention propose such a tool for detecting nerves, automatically and in real time, in a series of images originating from an ultrasound scan.

Such a tool must be able to deal with the essential nature of the echographic images, which include a significant amount of noise and numerous artifacts associated with echographic imaging. The variability of the nerve structures means that their appearance on the images is also highly varied and makes an automatic detection process even more difficult.

Furthermore, due to the critical nature of the work of the anesthetist, the automatic method must be reliable enough to minimize errors, despite the poor quality of the echographic images, whether this involves over-detection or under-detection.

Therefore, the aim of embodiments of the invention is to provide a method for automatic detection, the performance of which improves the existing techniques and significantly facilitates the work of the anesthetist.

### SUMMARY OF THE INVENTION

To this end, embodiments of the present invention propose a method for detecting a nerve in a series of echographic images comprising, for each image of the series:
a step of generating a map of probabilities over regions of the image, involving applying a plurality of pattern descriptors in order to generate, for each pixel of the regions, a vector determining the response of the pixel for each of the descriptors of the plurality of descriptors, then deducing a probability for each pixel of belonging to a nerve as a function of a probabilistic model;
a classification step applied on zones determined by the probability map, involving searching models, each corresponding to a nerve type, in a sliding window over the zones, assigning a degree of confidence to each position of the window for each model and retaining an optimum position for each model, then analyzing the consistency of these optimum positions by measuring their stability over a set of images of the series in order to select the window exhibiting the maximum consistency, the window corresponding to a detected nerve.

According to preferred embodiments, the invention comprises one or more of the following features, which can be used separately or partially or fully in combination with one another:
the method further comprises a step of extracting a contour of the nerve detected within the window;
the method comprises a preprocessing step for producing the regions, while eliminating other regions that cannot correspond to a nerve;
the preprocessing step comprises eliminating zones corresponding to the skin from the image;
the preprocessing step comprises eliminating zones not corresponding to hyperechogenic tissues;
the probabilistic model is a Gaussian mixture model;
the descriptors are based on Gabor filters;
the descriptors are adaptive median binary pattern descriptors, AMBP;
in the classification step, the models are constructed by a separators Wide Margin method.

A further aim of embodiments of the invention relate to a computer program comprising code that can be executed by digital equipment for implementing the method as previously described.

### BRIEF DESCRIPTION OF THE DRAWINGS

Further features and advantages of the invention will become apparent upon reading the following description of a preferred embodiment of the invention, which is provided by way of an example, and with reference to the accompanying drawings, in which:

FIG. 1 schematically depicts the processing chain according to one embodiment of the invention;

FIG. 2 schematically depicts an embodiment of the step of generating a probability map;

FIG. 3 schematically depicts an example for computing a median binary pattern descriptor, according to one embodiment of the invention;

FIG. 4 schematically depicts an embodiment of the classification step.

### DETAILED DESCRIPTION

In practice, the anesthetist scans a zone of the body of the patient with an ultrasound probe in order to identify the nerves and to determine the zone in which the anesthetic product is to be injected. The ultrasound equipment operates continuously and generates a stream of images (i.e. a video) that are displayed in real-time on a monitor at the disposal of the anesthetist or another practitioner (surgeon, etc.). Thus, the scan performed by the anesthetist can be undertaken on the basis of what they see on the monitor.

The method according to an embodiment the invention is based on a processing chain that takes the stream of echographic images as input and supplies a detection of a nerve on this stream as output.

Typically, this detection can involve highlighting the nerves as an overexposure on the stream of echographic images displayed on the monitor. For example, this highlighting can involve surrounding the detected nerve or even precisely defining the contours. It can be produced in color, in order to further facilitate the task of the practitioner.

Therefore, the detection must occur in real-time since it must be reflected on the monitor for visualizing echographic images and it must guide the action of the practitioner.

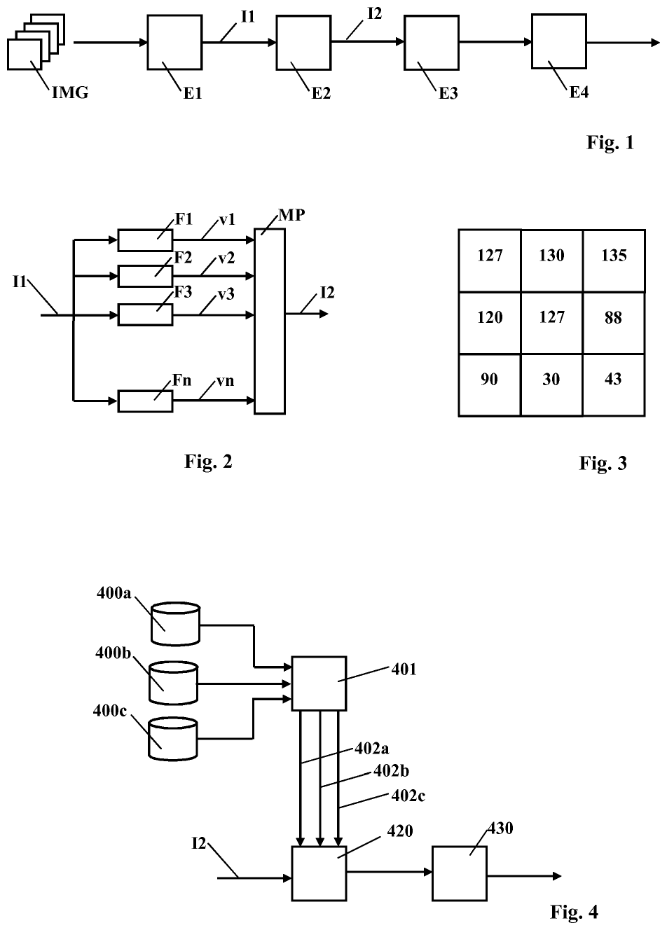

FIG. 1 illustrates the processing chain according to an embodiment of the invention.

A first step E1 can involve carrying out preprocessing on the IMG images originating from the echographic acquisition, which preprocessing is intended to reduce the effect of the noise and to eliminate certain regions from the images that can be easily dismissed since they cannot contain a nerve, in order to reduce the amount of data on which the subsequent steps of the processing chain will be applied.

This first step itself can comprise two distinct processing operations, applied to each image of the IMG stream:

According to the nerve block type that is targeted, a first processing operation can be adopted that involves extracting the hyperechogenic tissues. In medicine, reference is made to an organ or a hyperechogenic structure when it appears particularly white on an ultrasound scan. This whiteness is due to a larger reflection of the ultrasounds. In an echographic image, the nerves appear as hyperechogenic and hypoechogenic structures, with more or less round or oval shapes, forming a type of honeycomb structure with a particular pattern. For several nerve types (sciatic, median, ulnar) this pattern tends to have a hyperechogenic visual appearance. Furthermore, extracting hyperechogenic tissues ensures the selection of the zones that are likely to contain nerves, while dismissing the non-hyperechogenic zones and therefore limiting the volume that is to be subsequently processed.

To this end, several techniques are possible. The selection of a technique can depend on various factors, including the type of ultrasound probe that is used, which influences the characteristics of the generated images.

For example, Gaussian filtering can be applied in the first instance in order to reduce the noise, then a k-means partitioning algorithm or adaptive thresholding can be applied in order to classify each pixel of the processed image into one of two categories: the foreground, corresponding to hyperechogenic zones, and the background.

A second processing operation subsequently can be applied to the image in order to eliminate zones that can be dismissed for more “semantic” reasons. In particular, as the processed echographic image is used for the purposes of injecting an anesthetic product, it represents a region that is necessarily close to the skin. However, the dermis or epidermis have hyperechogenic characteristics that are similar to those of the nerves. It is therefore of interest to be able to extract the zone corresponding to the epidermis and to the dermis (i.e. to the skin) in order to facilitate the subsequent processing operations and to avoid any ambiguities between nerves and skin.

This skin zone can be eliminated using anatomical information: indeed, it is known that in the echographic image the skin is located toward the upper edge of the image and is several millimeters deep, corresponding to approximately ten pixels.

This region thus can be extracted, which region can correspond to a strip that is approximately ten pixels high, along the upper edge of the image.

This preprocessing is of interest as it reduces the detection errors, as well as the time required for the subsequent processing operations.

The second step E2 involves generating a probability map on the basis of the images I1 originating from the preprocessing, i.e. by only considering the pixels that are classified as belonging to a non-excluded “hyperechogenic” region as belonging to the skin zone.

This preprocessing E1 has indeed reduced some unnecessary information in the image, i.e. that could not correspond to a nerve, but this preprocessing E1 cannot isolate the nerves.

In this step E2, an approach that is based on the probabilities is used in order to establish a map indicating the zones that are likely to correspond to a nerve.

To this end, the pattern characteristics that correspond to the nerves are used. Each nerve type (median, sciatic, etc.) can have distinct patterns on an echographic image, but can exhibit a certain amount of variability, with this variability being further enhanced by the noise that is inherent in the ultrasound technique.

Pattern descriptors exhibiting good performance levels and good noise resistance are used. As each nerve type can exhibit different aspects on an echographic image, a set of models can be established, with each model being associated with a given descriptor.

Consequently, as shown in FIG. 2, distinct descriptors F1, F2, F3 . . . Fn are applied to each pixel of the preprocessed image I1 (i.e. for which pixels have already been excluded), each respectively providing a response representing the affiliation of the pixel with a pattern associated with a given nerve type.

The response of each filter is a vector of digital values, respectively v1, v2, v3 . . . vn.

It is then possible to establish a probability that a given pixel may or may not belong to a nerve by using these vectors.

More specifically, the descriptors can combine and use the advantages of various pattern representation techniques: Gabor filters, wavelets, local motifs, statistical descriptors, etc.

The article “Computer-aided detection system for nerve identification using ultrasound images: a comparative study”, by Oussama Hadjerci, Adel Hafiane, Donatello Conte, Pascal Makris, Pierre Vieryres and Alain Delbos, in Informatics in Medicine Unlocked 3, 2016, pp. 29-43, establishes a comparative table of many possible descriptors, applied to the particular case of nerve detection.

Among these descriptors, adaptive median binary pattern, or AMBP, descriptors can be particularly cited from the article “Adaptive Median Binary Patterns for Texture Classification”, by A. Hafiane, K. Palaniappan, G. Seetharamn, in Pattern Recognition (ICPR), 2014, 22nd International Conference.

By way of an example, Gabor filters also can be cited, but can be combined with “MBP” type pattern descriptors, which will be more specifically described hereafter.

Gabor filters are of interest as they tend to reduce the negative effects of the noise in the processed image, as they are based on bandpass filtering. For some nerve types, they can fulfil an interesting role. However, a purely frequency based approach is not sufficient for characterizing the impression of a nerve in the image, and it is more beneficial to combine the frequency analysis provided by the Gabor filters with other types of information drawn from the patterns.

Methods based on local binary patterns, or LBPs, allow the general characterization of the patterns, and of the nerve patterns in particular, to be improved. These LBPs have been particularly described in the article “Multiresolution gray-scale and rotation invariant texture classification with local binary patterns”, by T. Ojala, M. Pietikäinen and T. Maenpää, in IEEE Trans. Pattern Analysis and Machine Intelligence, vol. 24, no. 7, pp. 971-987, 2002.

The principle of computing an LBP descriptor is based on two main steps: the extraction of a texton, i.e. a binary pattern, or a texel, from a special local elementary structure, then the analysis of the distribution of the histograms of these textons.

This approach can be combined with the Gabor filters, as is particularly disclosed in the article “Local Gabor binary-pattern histogram sequence (lgbphs): a novel non-statistical model for face representation and recognition”, by W. Zhang, S. Shan, W. Gao, X. Chen and H. Zhang, in IEEE International Conf. Computer Vision, pages 786-791, 2005.

This combined approach, since referred to as “Local Gabor Binary Pattern”, LGBP, has appealing performance levels, but they are not sufficient for detecting nerves in echographic images, due to the significant amount of noise.

The LBP technique has been improved in order to increase its noise robustness, in order to provide the MBP, “Median Binary Pattern”, which has been described, for example, in the article “Median binary pattern for textures classification”, by A. Hafiane, G. Seetharaman, K. Palanaiappan and B. Zavidovique, in Lecture Notes in Computer Science (ICIAR), vol. 5112, pages 619-629, 2008.

The median binary pattern descriptor, MBP, is determined by matching, between the space, intensities of the image (values of the pixels) with a local binary pattern, by thresholding the pixels using the median value of a neighborhood centered on the current pixel. It is this thresholding with a median value that distinguishes the MBP descriptor from the LBP descriptor, in which the thresholding is carried out in relation to the value of the central pixel.

FIG. 3 depicts an example for computing an MBP with a typical neighborhood of 9 pixels (3×3). The median value τ is 120. Each pixel bₖ of the neighborhood is then compared with this median value and is thresholded in a binary manner. The values that are thus computed can be considered in the form of a binary vector or in a scalar form:

$$MBP ( x , y ) = {\sum }_{k = 0}^{L - 1} {2}^{k} H ( {b}_{k} - τ ) , \qquad ( 1 )$$

in this equation, L is the size of the neighborhood (L=9 in the example), bₖ is the value of the pixel k in this neighborhood, τ is the median value on the neighborhood, and MBP(x, y) therefore represents the MBP descriptor of the pixel of coordinates x, y.

Thus, each pixel of the image (not separated by the preprocessing step E1) is matched with a value MBP (x, y) of L bits.

The MBP can be combined with the Gabor filters in order to produce a new characterization technique: MGBP “Median Gabor Binary Pattern”.

In order to determine the MGBP descriptor of the position pixel (x, y), in the first instance, the image is convoluted with the nucleus of each of the Gabor filters.

The nuclei are provided by the expression:

$$g ( x , y ) = exp [ - \frac{1}{2} ( \frac{{x}^{′ 2}}{{σ}_{x}^{2}} + \frac{{y}^{′ 2}}{{σ}_{y}^{2}} ) ] \times cos ( 2 π {fx}^{′} ) ,$$

in which:

x′=x cos ϕ+y sin ϕ

y′=x sin ϕ+y cos ϕ

where ϕ, σ and f define the Gabor filter, with ϕ being the direction of the filter, σ being the standard deviation of the Gaussian envelope and f being the frequency of the cosine wave.

The magnitude z(x, y) of the response of the image to the Gabor filter is then provided by:

z(x,y)=|I(x,y)×g(x,y)|

where I(x, y) represents the value of the pixel of coordinate (x, y) in the preprocessed image I and g(x, y) is the value of the nucleus of the Gabor filter at the coordinates (x, y).

It is then possible to apply the principles of the MBP descriptors to the space of the response to the Gabor filter. By using the expression (1) provided above, the following is then obtained:

$$MGBP ( x , y ) = {\sum }_{k = 0}^{L - 1} {2}^{k} H ( {z}_{k} - \overline{z} ) ,$$

in which z̅ represents the median value of the response to the Gabor filter on the neighborhood of L neighbors around the point of coordinates (x, y).

An MGBP descriptor thus can be determined, forming a binary number of L bits (typically of 9 bits), for each pixel of the image and for each Gabor filter.

Thus, a vector V(x, y) is obtained for each pixel, which vector is formed by different values of each descriptor or filter at the coordinates (x, y):

V(x,y)=[v₁(x,y),v₂(x,y),v₃(x,y) . . . vₙ(x,y)]^{T},

where n is the number of MGBP descriptors.

As previously stated, such a vector can be obtained using other techniques and other pattern descriptors.

A probabilistic model can be constructed on the basis of these vectors, which model allows the probability that a pixel does or does not correspond to a nerve. One embodiment of this step involves using a Gaussian Mixture Model (GMM). A Gaussian mixture model is a statistical model expressed according to a mixture density. It is commonly used to parametrically estimate the distribution of random variables by modelling them as a sum of several Gaussians (called nuclei). This then involves determining the variance, the mean and the amplitude of each Gaussian. These parameters are optimized according to a maximum likelihood criterion in order to approach the desired distribution as closely as possible. This technique is suited to the variability of the region of a nerve.

A learning phase is required to construct this Gaussian mixture model and to compute its parameters. This procedure can be iteratively carried out via the Expectation-Maximization algorithm (EM).

Once the learning phase is complete, the obtained model can be used to compute the probability of each pixel corresponding to a nerve. The values v1, v2, v3 . . . vn originating from the filters F1, F2, F3 . . . Fn are thus taken as input for a probability computation module MP and the outcome of this step E2 is a map of probabilities I2 that associates, for each pixel of the processed images, a probability of belonging to a nerve. The zones excluded by the preprocessing step E1 can be excluded from this probability map or even can be automatically assigned a zero probability in this map.

According to the invention, a third step E3 is subsequently triggered, which is based on the results of the second step E2, i.e. on the map of probabilities I2.

More specifically, this third step involves finding the nerves using an algorithm for classification into zones determined by the probability map. In this way, the search zone is significantly limited to the zones of the image that correspond to a high value in the probability map, i.e. those most likely to correspond to a nerve. For example, the threshold above which a zone of the probability map can be transferred to the next step E3 for processing can be set to 70% or 80%.

This clearly allows the computation time to be reduced, but also allows the performance levels of the overall process to be improved by reducing the detection errors.

Various classification mechanisms (or “classifiers”) can be used. These classification mechanisms particularly can be based on machine learning mechanisms that allow models to be determined on the basis of a learning set. Comparing new probability maps with this set of models, by means of a sliding window, subsequently allows the nerves in the submitted images to be determined.

Among the mechanisms for forming models and for classification, several machine learning techniques can be used.

For example, “Deep Learning” can be cited. This designation covers a set of machine learning methods attempting to model data with a high level of abstraction by virtue of architectures allowing various non-linear transformations to be implemented.

Deep learning techniques cover various families of techniques, among which machine learning and neural networks can be cited.

Machine learning, is a sub-domain of the artificial intelligence that emerged in the 1950s. It covers systems made up of adjustable parameters, typically considered in the form of vector values, with a view to supplying the expected output for a series of data values as input. This type of learning is characterized by its ability to autonomously adjust its parameters based on the knowledge of the previously processed data.

In general, when applied to images and to the situation of the invention, these techniques are based on two phases:
an extraction of the characteristics of the processed image;
a classification that provides a category, in association with the processed image.

In general, the classifier determines the category according to a weighted sum of the components of the vector of characteristics. A threshold value is set so that the output may or may not be activated as a function of the preceding computation. When errors are identified as output, this algorithm will readjust its internal parameters with a view to improving the subsequent responses. This is then referred to as learning.

The neural networks allow non-linear classifications and particularly thus allow the inability of linear classifiers to determine non-linearly separable categories to be resolved. The neural networks are architectures, typically in successions of layers, of formal neurons. Conventionally, the first layer of the network is called the input layer, the internal layers of the network are called hidden layers, and the final layer is called the output layer. The neurons of successive layers are connected by weighted links and the weights allow the input signal to be propagated and “processed” in order to achieve the result of the classification on the output layer.

The weights are computed by learning, for example, by back propagating errors. In each layer, the neurons estimate a local error and transfer the gradient of the error onto the previous layer. Upon each iteration, the overall error is determined on the output layer and is propagated toward the lower levels. These mechanisms are described in the articles by Yann Le Cun, for example.

Another example is provided by the separators Wide Margin method (SVM), or “Support Vector Machines” (SVM). This involves a set of monitored learning techniques intended to resolve problems of discrimination and of regression. SVMs are a generalization of linear classifiers. SVMs were developed in the 1990s based on the theoretical considerations of Vladimir Vapnik in relation to the development of a statistical theory of learning: the Vapnik-Chervonenkis theory.

The separators Wide Margin methods are based on two key ideas: the notion of maximum margin and the notion of nucleus function, which allow non-linear discrimination problems to be processed and the classification problem to be reformulated as a quadratic optimization problem.

The margin is the distance between the separation boundary and the closest samples. The samples are called support vectors. In SVMs, the separation boundary is selected as being that which maximizes the margin.

This selection is supported by the Vapnik-Chervonenkis theory (or statistical learning theory), which demonstrates that the maximum margin separation boundary has the smallest capacity. The problem involves finding this optimum separation boundary from a learning set. This is achieved by formulating the problem as a quadratic optimization problem, for which known algorithms exist.

In order to be able to process cases in which the data are not linearly separable, the second key idea of SVMs is to transform the space for representing input data into a larger space (possibly with infinite dimensions), in which it is likely that a linear separation exists. This is achieved by virtue of a nucleus function, which must comply with the conditions of Mercer's theorem, and which has the advantage of not requiring explicit knowledge of the transformation to be applied for the change of space. The nucleus functions allow a scalar product in a large space, which is expensive, to be transformed into a simple specific evaluation of a function.

FIG. 4 schematically shows the mechanisms of this step E3 according to one embodiment.

A learning set 400a, 400b, 400c of images is formed that represents several nerve types. Typically, this set is formed by N sub-sets 400a, 400b, 400c, each representing a given nerve type and having to generate a distinct model, respectively 402a, 402b, 402c.

The sub-sets can comprise a fairly large number of samples in order to allow the generalization by the learning system. This mechanism is supported by the fact that the same nerve type can exhibit different visual aspects on an echographic image, in particular as a function of the patients, the position of the ultrasound probe, etc.

According to one embodiment, these models 402a, 402b, 402c are generated using the SVM technique, using Gaussian nuclei, implemented by the learning module 401.

Subsequently, in order to detect a nerve, the classifier 420 uses a sliding window on the image 410 in order to compare its content with each of the models 402a, 402b, 402c.

For each position of the sliding window, the distance from its content to the hyperplane corresponding to each of these models is computed. The greater this distance, the greater the degree of confidence that is accorded to its classification. For each model, only the position of the window that provided a classification as a nerve with the highest degree of confidence is ultimately retained.

The sliding window covers the entire probability map I2, so that at the end of the process, one position is obtained per learned model 402a, 402b, 402c.

The next step 430 involves using the temporal information to analyze the evolution of these positions, in the stream of echographic images. As has been seen, the ultrasound is captured using a probe that generates a stream of images. In the preceding steps, the processing operations were focused on a single image. However, the use of the temporal information, and therefore the consideration of the fact that a stream of images is available, can improve the precision and the effectiveness of the method according to the invention.

The idea in this case is to analyze the consistency of the detection of the position of the windows (for each model) over time: if this position remains stable over time, then the detected position can be considered to be good and a high probability can be assigned thereto. If, on the contrary, an inconsistency is observed in the detection of the position of the window, then this detection must be hindered by a weaker probability (or confidence index). This is provided that the anesthetic scans restricted zones of the human body.

The majority vote principle can be used: if the majority of the windows overlaps by at least 50% (for example) on a position and remains stable over a period of time, the location of the nerve is considered to be reliable. This period of time forms a time window preceding the present instant, on which the analysis is based, which must be coherent with the movements that the practitioner would have been led to take with the ultrasound probe.

This step thus allows determined windows to be dismissed that do not have a sufficient degree of temporal coherence. It also allows the time window to be selected that has the highest temporal coherence.

Various embodiments are possible for combining the degrees of confidence determined for each window and the temporal coherence. For example, this can involve a simple multiplication of the probabilities (degree of confidence×temporal coherence), to which different weights optionally can be assigned. However, other embodiments are possible.

The next step, E4, involves extracting the contour of the nerve. Determining a window in which the nerve is found optionally can suffice for assisting the task of the practitioner, but it can be advantageous for the contours of the nerve to be more precisely defined.

Digital processing of the definition of the nerve is clearly applied only to the window in which the nerve has been detected on completion of the preceding step, E3. This digital processing is therefore applicable to a limited amount of digital data.

Various techniques can be used to define the nerve within the window.

For example, adaptive thresholding techniques can be cited that have the advantage of being very fast to the detriment of average precision.

More specifically, active contour techniques can be cited. Active contours, also often called “snakes”, are deformable dynamic models formed by a series of movable points distributed along a two-dimensional curve in the plane of the processed image. The curve is initially placed in the window defining the nerve to be defined. Iteratively, the curve is modified according to behavior that is governed by evolutionary equations: the curve moves, iteration after iteration, and converges toward the contour of the nerve.

The behavior equations have several parameters determining the behavior of the active contour, such as its elasticity, its tolerance to noise, etc. They define the dynamic of the contour by being based on a notion of internal and external energy that the evolutionary algorithm attempts to minimize. Constraints allow a smooth curve to be maintained with equidistant points, while leaving the possibility of deformations on the contour. The internal energy corresponds to the morphology and to the characteristics of the curve (curvature, length, etc.). The external energy originates from the processed image and can be caused by the noise, the presence of contrasted edges, etc. In the context of an embodiment of the invention, the active contour is applied to the probability map, in a zone defined by step E3, and these are therefore the probabilities that generate the external energy of the active contour.

In particular, techniques of the PGVF type (“Phase-based probabilistic active contour” can be used, as described in the article “Phase-based probabilistic active contour for nerve detections in ultrasound images for regional anesthesia”, by A. Hafiane, P. Vieyres and A. Delbos, in Computers in Biology and Medicine, volume 52, 2014, pp. 88-95.

Of course, the present invention is not limited to the examples and to the embodiment that have been described and depicted, but it is subject to numerous variants that are accessible to a person skilled in the art.

1. A method for detecting a nerve in a series of echographic images comprising, for each image of the series:
a step (E2) of generating a map of probabilities over regions of the image, involving applying a plurality of pattern descriptors in order to generate, for each pixel of the regions, a vector determining the response of said tie pixel for each of the descriptors of the plurality of descriptors, then deducing a probability for each pixel of belonging to a nerve as a function of a probabilistic model;
a classification step (E3) applied on zones determined by the probability map, involving searching models, each corresponding to a nerve type, in a sliding window over the zones, assigning a degree of confidence to each position of the window for each model and retaining an optimum position for each model, then analyzing the consistency of these optimum positions by measuring their stability over a set of images of the series in order to select the window exhibiting the maximum consistency, the window corresponding to a detected nerve.

2. The method as claimed in claim 1, further comprising a step (E4) of extracting a contour of the nerve detected within the window.

3. The method as claimed in claim 1, comprising a preprocessing step (E1) for producing the regions, by eliminating other regions that cannot correspond to a nerve.

4. The method as claimed in claim 3, wherein the preprocessing step (E1) comprises eliminating zones corresponding to the skin from the image.

5. The method as claimed in claim 3, wherein the preprocessing step comprises eliminating zones not corresponding to hyperechogenic tissues.

6. The method as claimed in claim 1, wherein the probabilistic model is a Gaussian mixture model.

7. The method as claimed in claim 1, wherein the descriptors are based on Gabor filters.

8. The method as claimed in claim 1, wherein the descriptors are adaptive median binary pattern descriptors, AMBP.

9. The method as claimed in claim 1, wherein, in the classification step (E3), the models are constructed by a separators Wide Margin method.

10. A computer program comprising code that can be executed by digital equipment for implementing the method as claimed in claim 1.
